(19) United States
(12) Patent Application Publication
(10) Pub. No.: US 2006/0067241 A1
(43) Pub. Date: Mar. 30, 2006

(54) Reliable file transfers using protocol scripting

(76) Inventors: Robert Allen Lorentzen, Carrollton, TX (US); David M. Newman, Sachse, TX (US); Joseph D. Knape, Allen, TX (US)

Correspondence Address: TEXAS INSTRUMENTS INCORPORATED, P O BOX 655474, M/S 3999, DALLAS, TX, 75265, US

(21) Appl. No.: 10/952,664

(22) Filed: Sep. 29, 2004

(51) Int. Cl. H04L 12/26; H04J 3/14

(52) U.S. Cl. 370/252; 370/400; 370/428; 714/746

(57) ABSTRACT

System and method for providing reliable file transfers in a computing environment with a network with multiple communications protocols. A preferred embodiment comprises creating a script file containing a file to be transferred from a first device to a second device and the script file is then transferred to a network interface between the first device and the second device. The network interface can then execute the script commands in the script file. After the network interface executes the script file, the first device is notified of the execution of the script file.

### TECHNICAL FIELD

The present invention relates generally to a system and method for communications in a computing environment, and more particularly to a system and method for providing reliable file transfers using protocol scripting in a computing environment with a network with multiple communications protocols.

### BACKGROUND

In many computing environments, it can be common to have many devices communicating with one another while using different communications protocols. In order to provide interoperability, software or hardware bridges are required as protocol translators to permit the devices using the different communications protocols to communicate with each other and to transfer files and data. The bridges translate communications in one communications protocol into communications in another communications protocol.

When the communications protocols are designed to properly handle situations that may arise in the transfer of data and files (collectively referred to as file transfers), such as errors, time-outs, re-transmissions, and so forth, the communications between devices can be straight forward and can occur with relatively small delay and at low latency. These communications protocols can be said to be network aware. However, when a communications protocol is not network aware, meaning that they may not be able to gracefully handle events such as transmission errors, time-outs, and so on, then communications between devices may not properly complete when one (or more) of these events occur during a transmission. For example, if a transmission occurs between two devices, wherein the two devices (a first and a second device) use different communications protocols (therefore, a bridge is required), and if an error were to occur during the transmission between the first device and the bridge and if a second communications protocol used between the bridge and the second device was not network aware (a first communications protocol being used between the first device and the bridge), then the missing information (due to the error in the transmission) may not be delivered to the second device since the second communications protocol could not properly handle the erroneous transmission (and possibly the subsequent re-transmission).

One technique that can be used is to simply retransmit failed transmissions. When a transmission between devices fail, then the transmission is repeated until the transmission completes successfully.

Another technique that can be used is to decrease the amount of data that is transferred, i.e., reduce the transmit data block size. Reducing the transmit data block size can help to improve the performance by reducing the amount of time that the data is in the network, thereby reducing the probability of errors. Additionally, the re-transmission of a small data block can occur more rapidly than the re-transmission of a large data block. Therefore, if an error were to occur, the recovery can take place more rapidly.

Yet another technique that can be used would be to upgrade the communications protocols that are not network aware. By upgrading the non-network aware communications protocols, graceful recovery to file transfer errors, time-out, and so forth can be provided to all devices in the computing environment.

One disadvantage of the prior art is that the repeating of the transmission until it succeeds does not correct the problem and that the number of repeated transmissions can be very large if there is a large number of errors in the transmissions. The repeated transmissions can also greatly increase the effective transfer time of a file transfer.

A second disadvantage of the prior art is that certain critical transfers may not be permitted since the cost of a failed transmission can be too high. Therefore, special procedures may be needed to perform the critical transfers. For example, a transfer performing an upgrade in the firmware of a device should not be attempted since a failed transfer can render the device inoperable. To accomplish the upgrade via a file transfer, it may then be necessary to connect the device to a separate communications network, wherein the communications is sufficiently reliable to perform the file transfer.

Yet another disadvantage of the prior art is that the use of small transmit data blocks can increase the communications overhead. High communications overhead can reduce the efficiency of the communications and reduce the overall file transfer rate.

Another disadvantage of the prior art is that some devices may not be upgradeable. Therefore, in order to use those devices, their non-network aware communications protocols will need to be maintained.

### SUMMARY OF THE INVENTION

These and other problems are generally solved or circumvented, and technical advantages are generally achieved, by preferred embodiments of the present invention which provides for a system and method for providing reliable file transfers using protocol scripting in a computing environment with multiple communications protocols.

In accordance with a preferred embodiment of the present invention, a method encoding a file for transfer across multiple networks is provided. The method comprises logically joining adjacent networks with network aware communications protocols into composite networks, and then starting with an interface between a first composite network and a second composite network, creating a script file using communications protocol instructions used by the second composite network, wherein the communications protocol instructions are used to transfer the file across the second composite network. The creating is repeated at remaining interfaces between consecutive composite networks in a reversed order, starting at the destination.

In accordance with another preferred embodiment of the present invention, a method for transferring a file across multiple networks is provided. The method comprises creating a script file at a first device, transferring the script file to a network interface between the first device and a second device, executing the script file at the network interface, and informing the first device of the execution of the script file.

In accordance with another preferred embodiment of the present invention, a network hub comprising a first network interface, a second network interface, a processor, and a memory is provided. The first network interface is coupled to a first network connection and the second network interface is coupled to a second network connection. The processor is coupled to the first network interface and the second network interface, while the memory is coupled to the processor. The processor is configured to execute script commands provided by the first network connection to transfer data and instructions through the first network interface and the second network interface, while the memory is configured to store implementations of script commands, programs, and data.

An advantage of a preferred embodiment of the present invention is that a file transfer between devices can be broken up into multiple stages with buffering of the data being transferred at each stage, wherein a single stage involves the use of a single communications protocol without any translation. Therefore, the error handling built into the communications protocol can be used to handle events such as errors, time-outs, re-transmits, and so forth, with no interaction between the different communications protocols.

A further advantage of a preferred embodiment of the present invention is that the devices do not need to be upgraded to make use of network aware communications protocols. This permits the continued use of devices that cannot be upgraded, rather than requiring their replacement with newer devices.

Yet another advantage of a preferred embodiment of the present invention is that since the file transfers are now reliable, critical transfers, such as updates, can be performed. This can eliminate the need to perform special tasks to update devices, for example.

Another advantage of a preferred embodiment of the present invention is that the transmit data block size does not need to be reduced to improve transfer reliability. In fact, the transmit data block size can be increased to improve transfer data rates and times by reducing the overall communications overhead.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of a computing environment with a network with multiple communications protocols;

FIGS. 2a and 2b are diagrams of a file transfer between a host computer and a client device with and without transmission errors;

FIG. 3 is a diagram of physical and virtual connections for a logically partitioned view of a computing environment, according to a preferred embodiment of the present invention;

FIGS. 4a and 4b are diagrams of a file transfer between a host computer and client device over multiple networks using communications protocol scripting, according to a preferred embodiment of the present invention;

FIG. 5 is a diagram of virtual links involved in communications protocol scripting on a layered view of a computing environment, according to a preferred embodiment of the present invention;

FIGS. 6a and 6b are diagrams of the virtual links involved in communications protocol scripting in a computing environment with multiple bridges and the encapsulation of the file to be transferred in such a computing environment, according to a preferred embodiment of the present invention;

FIGS. 7a and 7b are diagrams of sequences of events involved in the transfer of a file to and from a host computer, according to a preferred embodiment of the present invention; and

FIG. 8 is a diagram of a detailed view of a hub with modifications to support communications protocol scripting, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a computing environment wherein file transfers can take place between a host computer and a series of client devices (electronic calculators) over a transmission link comprising a wireless link and a proprietary wired link, wherein the communications protocol used on the proprietary wired link is not network aware. The invention may also be applied, however, to other computing environments, wherein devices communicate using multiple communications protocols, with some of the communications protocols being non-network aware.

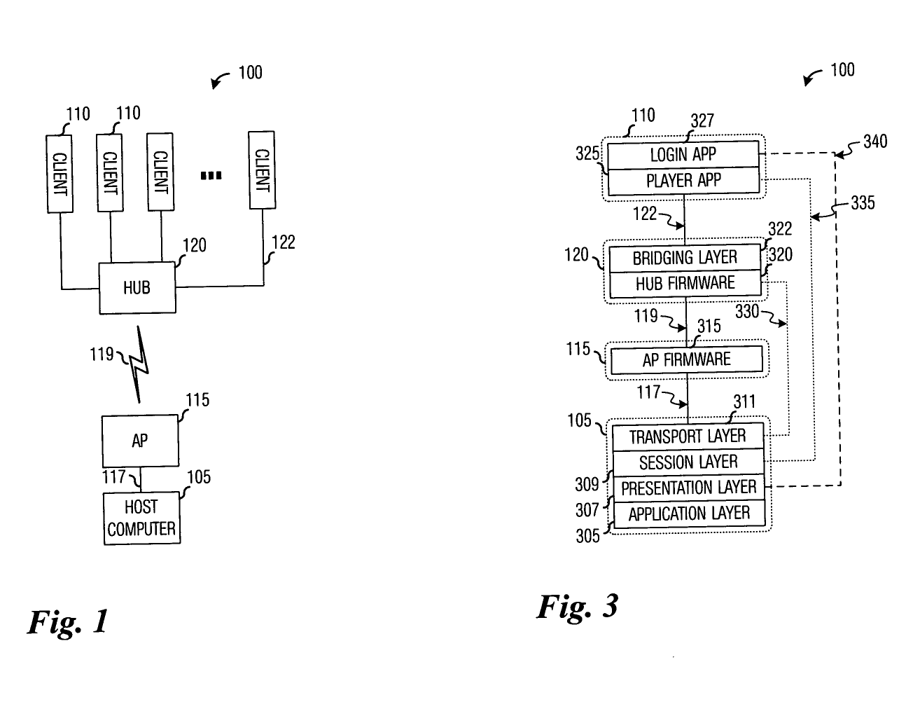

With reference now to FIG. 1, there is shown a diagram illustrating a computing environment 100 with a network with multiple communications protocols. The computing environment 100 may include a host device (a host computer) 105 coupled to a plurality of client devices (such as client device 110). The host computer 105 can be coupled to the client device 110 via a wireless network. An access point 115, coupled to the host computer 105 via a network link 117 or directly contained in the host computer 105, can be used to wirelessly couple (via wireless link 119) the host computer 105 to a hub 120 that can be used to provide connectivity for the client device 110. The hub 120 and the client device 110 can be connected via a wired connection 122. Note that the host computer 105 may be coupled to the client device 110 in a different manner, such as by a wired link (not shown) rather than the wireless link 119. Note that should the host computer 105 be coupled to the client device 110 via wired link, the access point 115 may not be necessary. Additionally, the hub 120 can use a wireless link (not shown) to connect to the client device 110. The connectivity of the computing environment 100 can differ from what is shown in FIG. 1 without changing the problems that may be involved with the use of a non-network aware communications protocol(s) in conjunction with a network aware communications protocol(s).

With reference now to FIG. 2a, there is shown a diagram illustrating the progress of a file transfer between the host computer 105 and the client device 110. Note that the term data transfer can be used interchangeably with file transfer. A common approach to performing a file transfer between the host computer 105 and the client device 110 could be to directly transfer the data in the file (shown as a file 205) between the host computer 105 and the client device 110 with the hub 120 serving solely as a bridge between the different communications protocols used. Bridges and the use of bridges in networks are considered to be well understood by persons of ordinary skill in the art of the present invention and will not be discussed herein. The transfer of the file 205 is shown as the arrow 210. Note that while a single hub is shown, it may be possible for the file transfer to take place over several hubs, wherein the file is transferred over multiple network links.

When a direct transfer is used, the hub 120 can be used as bridge to translate a first communications protocol (used from the host computer 105 to the hub 120) into a second communications protocol (used from the hub 120 to the client device 110). Note that prior to arriving at the hub 120, the file may have been transferred over several network links and bridges. For example, from the host computer 105, the file may have been transferred to the access point 115 via a wired network link (network link 117 (FIG. 1)) using a communications protocol such as IEEE 802.3 and then from the access point 115 to the hub 120 via a wireless network link (wireless link 119 (FIG. 1)) using a communications protocol such as IEEE 802.11b. Since both IEEE 802.3 and IEEE 802.11b are network aware communications protocol, it can be possible to logically combine the two communications protocols and the network links that use them into one and represent the two communications protocols and network links as a single communications protocol and network link. Typically, the hub 120 does not perform any buffering of the data (other than the buffering that is necessary to perform the translation) and as soon as it receives a sufficient amount of data and it is able to perform the translation, the hub 120 will send the translated data onto the client device 110. The network link between the hub 120 and the client device 110 may be a wired or wireless, point-to-point link and can be proprietary in nature.

A problem that can arise with the hub 120 operating as a simple bridge is that if, due to an error or some other unforeseen delay, data being transferred from the host computer 105 to the hub 120 does not arrive at the expected time, the hub 120 could stop sending data to the client device 110, which could lead to the occurrence of a time-out. This may result in a failed transmission. Alternatively, the hub 120 could transmit NULL data to the client device 110, which can lead to the NULL data being erroneously used as actual data.

With reference now to FIG. 2b, there is shown a diagram illustrating the occurrence of errors in a transmission from a host computer to a hub and a possible result from the errors. FIG. 2b illustrates the transfer of the file 205 from the host computer 105 to client device 110 via the hub 120 using a direct transfer. As shown in FIG. 2b, the file 205 can be broken up into five blocks: B1 255, B2 260, B3 265, B4 270, and B5 275. The first block “B1” 255 is successfully transferred from the host computer 105 to the hub 120 (shown as arrow 256) and then from the hub 120 to the client device 110 (shown as arrow 257). However, the second block “B2” 260 is not successfully transferred from the host computer 105 to the hub 120 (shown as crossed out arrow 261). Since the second block “B2” 260 did not arrive at the hub 120, the transfer of the second block “B2” 260 to the client device 110 times out (shown as dashed arrow 262) or NULL data is transmitted to the client device 110. Similarly, the third block “B3” 265 does not arrive at the hub 120 (crossed out arrow 266) and the transfer to the client device 110 times out (dashed arrow 267). The fourth and fifth blocks “B4” 270 and “B5” 275 arrive at the hub 120 (arrows 271 and 276) and are transferred to the client device 110 (arrows 272 and 277).

Out of the five blocks making up the file 205, the client device 110 only receives blocks “B1” 255, “B4” 270, and “B5” 275, with the transfers of blocks “B2” 260 and “B3” 265 timing out. Therefore, the transfer of the file 205 was unsuccessful and another attempt to transfer the file may be made. Note that the additional file transfer attempts may or may not be successful. If additional file transfer attempts continue to be unsuccessful, the file transfer may be aborted.

In many communications protocols, when a packet transmission fails (either through an error damaging the packet or the packet takes too much time to arrive at a destination), an attempt at retransmitting the packet can be made. In either case, it is possible that the packet successfully arrives at the destination (at the hub 120, for example) on the retransmission attempt. However, since there is a delay between the expected arrival time of the packet and its actual arrival time, timing constraints of the communications protocol used to transmit the packet from the hub 120 to the client device 110 can be violated. This can lead to a failed transfer.

With reference now to FIG. 3, there is shown a diagram illustrating physical and virtual connections for a logically partitioned view of the computing environment 100 shown in FIG. 1, according to a preferred embodiment of the present invention. Physically, the devices in the computing environment 100 can be logically partitioned onto layers, based on their functionality. The host computer 105 can be partitioned into four layers: an application layer 305, a presentation layer 307, a session layer 309, and a transport layer 311. The application layer 305 can permit the execution of user and system programs, while the presentation layer 307 may be used to prepare data and establish file transfer connections (such as a file transfer link 340) with client device 110. The session layer 309 can be used to establish virtual links between the host computer 105 and the client device 110 (such as link 335) and the transport layer 311 can control a virtual link between the host computer 105 and the hub 120 (and other devices coupled to the host computer 105 via the access point 115) with a TCP/IP link 330.

The access point 115 can simply be represented by an access point firmware layer 315, which can be responsible for controlling the operation of the access point 115, including translating transmissions from a wireless communications protocol into a wired communications protocol and vice versa. The hub 120 can be logically partitioned into a hub firmware layer 320 and a bridging layer 322. The hub firmware layer 320 can be responsible for controlling the operation of the hub, while the bridging layer can be responsible for translating transmissions from a wireless communications protocol into a communications protocol consistent with the communications protocol by the client device 110. The client device 110 can be logically partitioned into a player application layer 325 and a login application layer 327. The player application layer 325 can be used to establish a virtual link to the host computer 105 and present data to a user of the client device 110, while the login application layer 327 can establish a session context for file transfers.

While a file transfer over several network links using a multitude of communications protocols may be unreliable due to differences in the way that events, such as errors, time-outs, re-transmissions, and so forth, are handled by the different communications protocols, a file transfer using a single communications protocol can be extremely reliable as long as the communications protocol has built-in error recovery or if the network has low error rates, since there are no potential inter-communications protocol incompatibilities when it comes to error handling. Communications protocol scripting, along with some potentially minor modifications to bridges, can be a way to exploit reliable file transfers using a single communications protocol to help make file transfers using multiple communications protocols reliable.

Communications protocol scripting can involve the encapsulation of the file to be transferred into a script file containing instructions of a communications protocol used by the network links over which the file will be transferred. For example, if a file is to be transferred over two network links, wherein each network link (a first and a second network link) communicates using a different communications protocol, then the file can be encapsulated into a script file containing instructions of a communications protocol used by the second network link and then the encapsulated file can be transferred over the first network link to a bridge using a communications protocol used by the first network link, which can then execute the instructions contained in the encapsulated file to transfer the file over the second network link.

In general, if the file is to be transferred over multiple network links that use a total of N unique communications protocols, then the file can be repeatedly encapsulated a total of N-1 times with the N-1 unique communications protocols in a reverse order, starting with the final communications protocol to be used and then moving in a reverse manner to the second communications protocol to be used. Note that it may not be necessary to encapsulate the file with an initial communications protocol since the initial transfer of the file to the first bridge will already be made using the initial communications protocol and it may not be necessary to provide the communications protocol instructions to the host computer 105. Then, as the encapsulated file is transferred from bridge to bridge, the bridge can execute the instructions that contain the encapsulated file to transfer the encapsulated file to a subsequent bridge. This can be repeated until the file arrives at its destination. Note that consecutive communications protocols that are network aware can be logically combined into a single communications protocol.

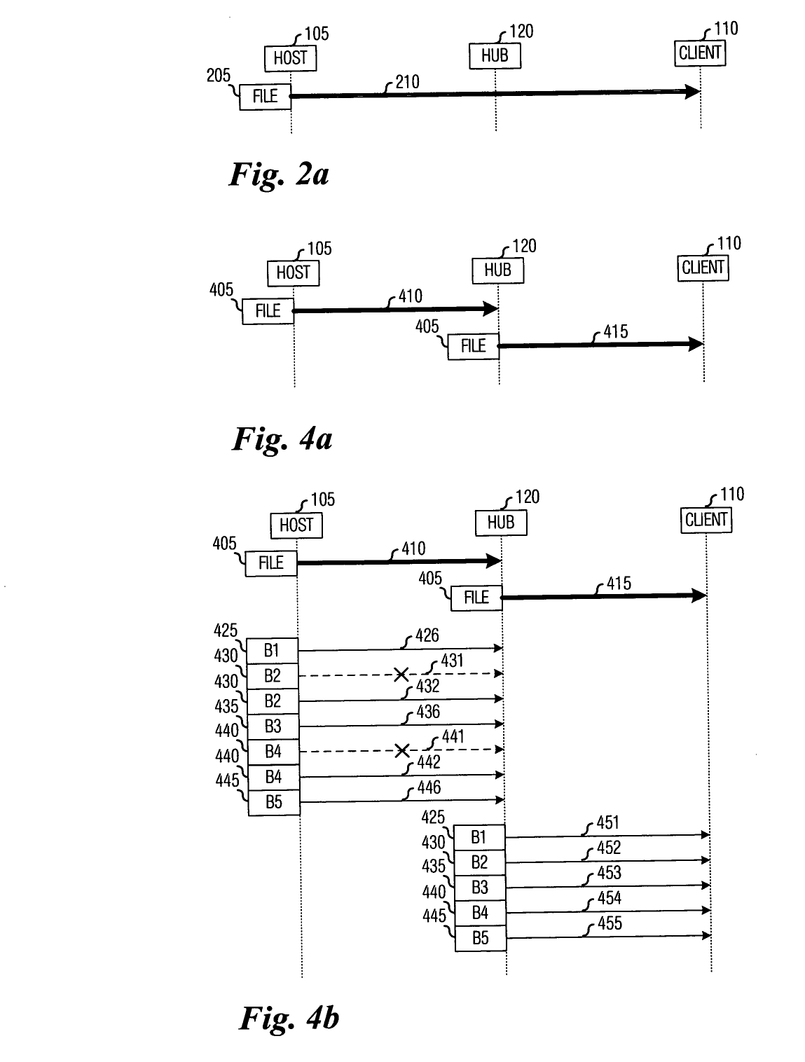

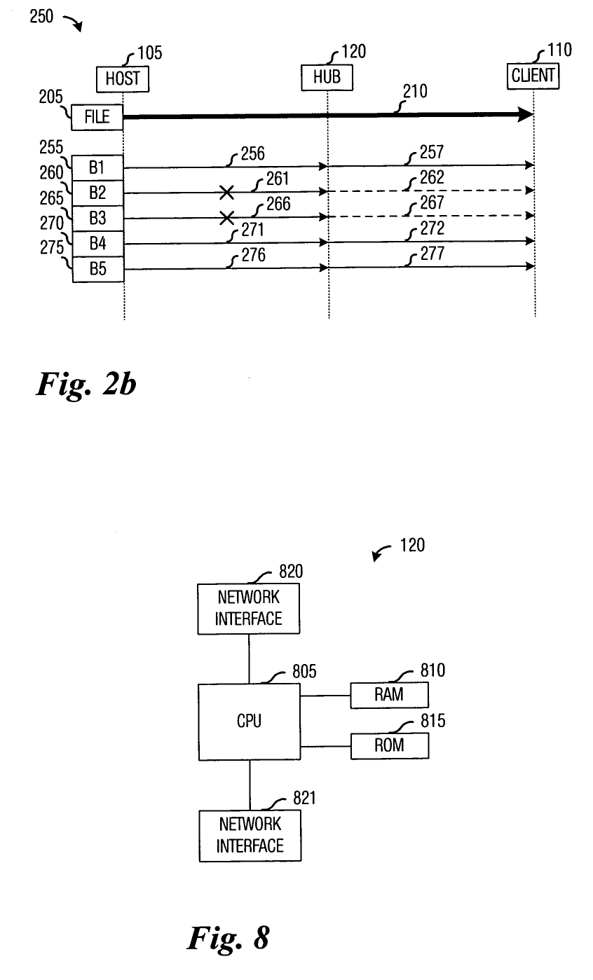

With reference now to FIG. 4a, there is shown a figure illustrating the progress of a file transfer between the host computer 105 and the client device 110, wherein communications protocol scripting is used to help improve the reliability of the file transfer, according to a preferred embodiment of the present invention. As shown in FIG. 4a, the transfer of a file 405 takes place over network links that make use of an initial communications protocol, which may be a single communications protocol or a combination of multiple network aware communications protocols, to the hub 120 and then from the hub 120 to client device 110 using a second communications protocol. Prior to transferring the file 405 to the hub 120 (shown as arrow 410), the file 405 can be encapsulated in instructions compatible with the second communications protocol. As the file 405 is received at the hub 120, the hub 120 can buffer the file 405. After the hub 120 has received the file 405 in its entirety, the hub 120 can execute the instructions containing the encapsulated file to transfer the file 405 to the client device 110 (shown as arrow 415).

With the use of the communications protocol scripting, the hub 120 (or a bridge) can use native communications protocols without having to implement each possible communications protocol. This can reduce software and hardware requirements. Furthermore, the local execution of the communications protocol should preserve typical unit-to-unit timing and so forth, thereby enabling transfer reliability approaching that of a single communications protocol transfer.

With reference now to FIG. 4b, there is shown a diagram illustrating the progress of a file transfer between the host computer 105 and client device 110, wherein communications protocol scripting is used to help improve the reliability of the file transfer in the presence of transmission errors, according to a preferred embodiment of the present invention. As shown in FIG. 4b, the transfer of the file 405 (in the form of individual blocks) from the host computer 105 to the hub 120, may encounter some transmission errors. The transfer successfully completes for a first block “B1” 425 (shown as arrow 426), however, the transfer of a second block “B2” 430 fails (shown as crossed out arrow 431). Since the transfer failed, the transfer of the second block “B2” 430 can be reattempted and upon the retry, the transfer succeeds (shown as arrow 432). The transfer of a third block “B3” 435 succeeds (shown as arrow 436), while the transfer of a fourth block “B4” 440 fails (shown as crossed out arrow 441). A second attempt at transferring the fourth block “B4” 440 succeeds (shown as arrow 442) and the transfer of a fifth block “B5” 445 occurs without incident (shown as arrow 446). As each block is successfully transferred to the hub 120, the block is buffered by the hub 120.

Once all five blocks of the file 405 are buffered at the hub 120, the hub 120 can execute the instructions encapsulating the file 405. Since the transfer of the file 405 from the hub 120 to the client device 110 is over a wired connection, the likelihood of an error is very low and all five blocks are transferred successfully on the respective first attempts (shown as arrows 451, 452, 453, 454, and 455).

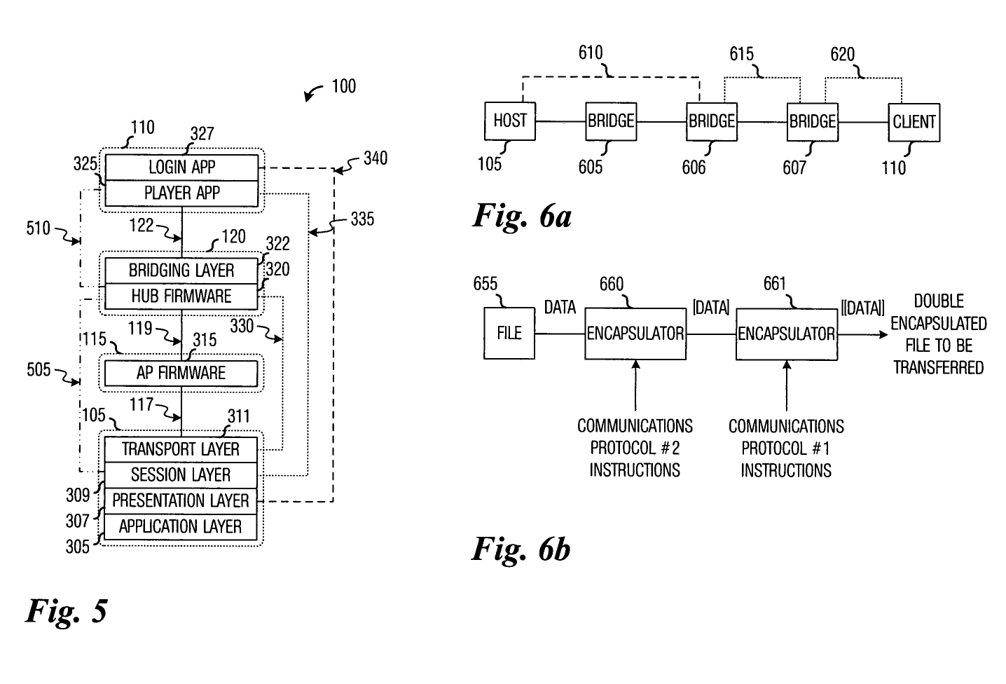

With reference now to FIG. 5, there is shown a diagram illustrating virtual links involved in communications protocol scripting on a layered view of the computing environment 100, according to a preferred embodiment of the present invention. The layered view of the computing environment 100 is as shown in FIG. 3. The virtual links involved in communications protocol scripting can be grouped into two types, a script link 505 and a software protocol link 510. The script link 505 encompasses the network links involved in transferring the file that has been encapsulated in instructions of a non-network aware communications protocol. The network links included in the script link 505 make use of communications protocols that are network aware and therefore can be logically combined into a single network link. For example, the script link 505, as shown in FIG. 5, encompasses the network link 117 and 119. As discussed previously, the network link 117 makes use of the IEEE 802.3 communications protocol and the network link 119 makes use of the IEEE 802.11b communications protocol.

The software link 510 encompasses the network links that make use of a single non-network aware communications protocol. As shown in FIG. 5, the software link 510 encompasses the network link 122, which as discussed previously makes use of a wired, proprietary, point-to-point communications protocol. Note that if there are several non-network aware communications protocols used by the network links involved in the transfer of the file, then there could be several software links 510 instead of the single software link 510 shown in FIG. 5. Additionally, in a complex computing environment, wherein there can be a mix of network aware and non-network aware communications protocols, it may be possible to have multiple script links and software links representing a single file transfer.

With reference now to FIG. 6a, there is shown a diagram illustrating communications protocol scripting links in an exemplary computing environment, according to a preferred embodiment of the present invention. The computing environment comprises the host computer 105 transferring files to and from the client device 110, wherein the file transfer takes place over several network links, each using a different communications protocol, and several bridges (such as bridge 605, 606, and 607). A script link 610 encompassing a pair of network links that use network aware communications protocols permits a single link to represent the two communications protocols. A first software link 615 represents a first non-network aware communications protocol over a network link between bridges 606 and 607 and a second software link 620 represents a second non-network aware communications protocol over a network link between bridge 607 and the client device 110. Note that since communications protocols between the bridges 606 and 607 and the bridge 607 and the client device 110 are non-network aware, they cannot be combined.

The use of the two non-network aware communications protocols (on the network links between the bridges 606 and 607 and the bridge 607 and the client device 110) requires the host computer 105 to encapsulate the file to be transferred twice, a first time using the instructions of non-network aware communications protocol used on the network link between the bridge 607 and the client device 110 and a second time using the instructions of the non-network aware communications protocol used on the network link between the bridges 606 and 607. The presence of network aware communications protocols between the host computer 105 and the bridge 606 (the script link 610) can allow the host computer 105 to transfer the doubly encapsulated file to the bridge 606, then the bridge 606 can strip the first set of communications protocol instructions from the doubly encapsulated file and transfer the now singly encapsulated file to the bridge 607. The bridge 607 can then strip and execute the communications protocol instructions contained in the singly encapsulated file to transfer the un-encapsulated file to the client device 110.

With reference now to FIG. 6b, there is shown a diagram illustrating the encapsulation of a file to be transferred from the host computer 105 to the client device 110 in a computing environment as shown in FIG. 6a, according to a preferred embodiment of the present invention. To produce the encapsulated versions of the file to be transferred, the host computer 105 can use an encapsulator (such as encapsulator 660 and 661) to place the file to be transferred inside a series of instructions from a communications protocol, which the host computer 105 can provide to the encapsulator. Since the host computer 105 has to encapsulate the file to be transferred twice, the host computer 105 can make use of two encapsulators or provide an initial output of an encapsulator back into itself. After the initial encapsulation, the data in the encapsulated file 655 can be denoted [data] and after the second encapsulation, the data in the doubly encapsulated file can be denoted [[data]]. Note that as discussed previously, the encapsulation needs to be performed in a reversed order, with the instructions from the last communications protocol used (the communication protocol used in the final network link prior to the client device 110) being encapsulated first.

In a network configuration wherein the source of the file to be transferred can initiate the transfer, a file transfer occurs in one direction, from the source (either the host computer 105 or the client device 110) to the destination (either the client device 110 or the host computer 105). However, in a network configuration wherein a single entity initiates all file transfers, a file transfer between the host computer 105 and the client device 110 can occur in one of two directions: from the host computer 105 to the client device 110 or from the client device 110 to the host computer 105. In such a configuration, the communications protocol scripting can differ slightly depending upon the source of the file to be transferred.

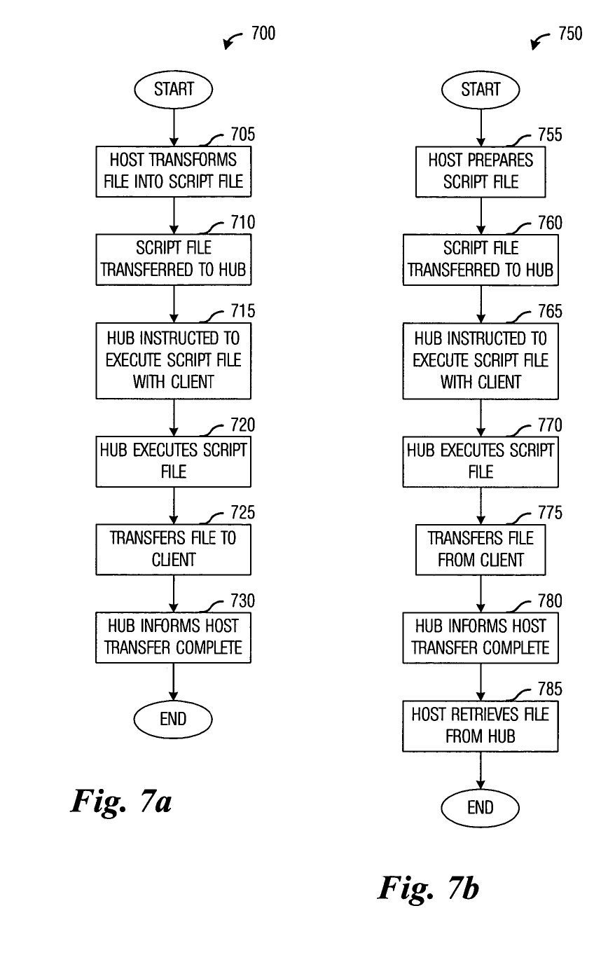

With reference now to FIGS. 7a and 7b, there are shown diagrams illustrating sequences of events illustrating the transfer of a file from the host computer 105 to the client device 110 (sequence 700) and the transfer of a file from the client device 110 to the host computer 105 (sequence 750), wherein the host computer 105 initiates both types of file transfers, according to a preferred embodiment of the present invention. According to a preferred embodiment of the present invention, the host computer 105 is used to initiate both types of file transfers (transferring a file from the host computer 105 to the client device 110 and to the host computer 105 from the client device 110) in a computing environment wherein the hub 120 is used as a bridge between a network aware communications protocol(s) (between the host computer 105 and the hub 120) and a non-network aware communications protocol (between the hub 120 and the client device 110).

The transfer of a file from the host computer 105 to the client device 110 can begin with the host computer 105 transforming the file into a script file (block 705). The transformation of the file into a script file can involve the encapsulation of the contents of the file with communications protocol instructions that are compatible with the communications protocol used in the network link(s) between the hub 120 and the client device 110. Note that depending upon factors such as file size, script file size limits, and so forth, the host computer 105 may transform the file into one or more script files. After transforming the file into a script file, the host computer 105 can transfer the script file to the hub 120 (block 710) using the communications protocol of the network link between the host computer 105 and the hub 120. Note in transferring the script file to the hub 120, the host computer 105 (or a network interface located in the host computer 105) may have to execute instructions compatible with the communications protocol of the network link between the host computer 105 and the hub 120. However, since the host computer 105 is directly coupled to the network link (through the network interface), it should have, as part of its network stack, a native implementation of the communications protocol and therefore does not need the use of a script file to perform the file transfer.

After the script file has been transferred by the host computer 105 to the hub 120, the hub 120 can be instructed by the host computer 105 to execute the scripts contained in the script file (block 715). When the hub 120 executes the script file (block 720), the contents of the file can be transferred to the client device 110 (block 725). Since the hub 120 is directly connected to the client device 110, the hub 120 should have a native implementation of the communications protocol used to connect the client device 110 to the hub 120. Therefore, the communications between the hub 120 and the client device 110 will preserve the typical unit-to-unit timings involved in a typical transfer and a reliable transfer should be ensured. As the hub 120 finishes the execution of the script file, the hub 120 can notify the host computer 105 that it has successfully transferred the file to the client device 110 (block 730).

The transfer of a file from the client device 110 to the host computer 105, wherein the host computer 105 initiated the file transfer, is similar to the transfer of a file from the host computer 105 to the client device 110. The file transfer can begin with the host computer 105 preparing a script file (block 755). The script file can contain a request for the file from the client device 110. After preparing the script file, the host computer 105 can transfer the script file to the hub 120 (block 760). After the script file has been transferred to the hub 120, the host computer 105 can instruct the hub 120 to execute the script file (block 765).

When the hub 120 executes the script file (block 770), a request can be sent to the client device 110 to transfer the file to the hub 120. Upon receiving the request for the file, the client device 110 transfers the file to the hub 120 (block 775). In order to initiate the transfer of the file from the client device 110, the host computer 105 must be able to reference the file in some fashion. For example, the host computer 105 may specify a name for the file, a location (or locations) in memory where the file is stored, and so forth. After the hub 120 has received the file from the client device 110, the hub 120 informs the host computer 105 that the transfer of the file is complete (block 780). The host computer 105 can then retrieve the file from the hub 120 (block 785).

With reference now to FIG. 8, there is shown a diagram illustrating a detailed view of the hub 120 with modifications to support communications protocol scripting, according to a preferred embodiment of the present invention. The hub 120 can include a central processing unit (CPU) 805, which can be responsible for controlling the operation of the hub 120. Alternatively, a micro-controller or a custom designed integrated circuit can be used in place of the CPU 805 to provide control for the operation of the hub 120. The CPU 805 can also execute script files containing communications protocol instructions for use in the transfer of files through the hub 120. This can be accomplished by a command interpreter (not shown) executing in the CPU 805 that can convert commands in the script files into network instructions for transferring data and instructions over network links. Since the script instructions can be general in nature, the command interpreter can implement communications protocols that are used only by networks coupled to the hub 120, thereby potentially reducing the complexity and size of the implementation of the command interpreter. The implementations of the communications protocol instructions can be stored in a memory.

Coupled to the CPU 805 can be the memory, in the form of random access memory (RAM) 810 and read-only memory (ROM) 815. The RAM 810 can be used for temporary storage of programs, scripts, data, files, and so forth, that can be loaded into the hub 120 after it has been powered on. The ROM 815 can be used to permanently store programs, scripts, configuration information, and so on, that can be needed to ensure the immediate operation of the hub 120 after being powered on.

The ROM 815 may contain a minimum set of scripts that will allow the hub 120 to perform rudimentary file transfers with the host computer 105 and the client device 110. However, should additional functionality be desired, it can be possible to download additional scripts to the hub 120 from the host computer 105, into the RAM 810. Furthermore, the hub 120 can be provided the ability to support additional communications protocols via downloads from the host computer 105 into the RAM 810.

The hub 120 can feature two (or more) network interfaces 820 and 821. The network interfaces 820 and 821 can permit the hub 120 to communicate with other devices via network links. Since the hub 120 can operate as an interface between different networks, the hub 120 features at least two network interfaces, with a network interface being necessary for each type of network connecting to the hub 120. Note that a network interface can permit the connection of more than one device to the hub 120. For example, more than one client device 110 can be connected to the hub 120. Note that the hub 120 may also contain other hardware and software that can function as “glue” hardware and software to ensure the proper operation of the hub 120. For simplicity purposes, the glue hardware and software is not shown in FIG. 8.

A preferred embodiment of the present invention permits the exchange of files between a host computer and electronic calculators that are wirelessly coupled together, wherein the electronic calculators are connected to a wireless hub via a proprietary point-to-point network that does not have full network awareness and the wireless hub is connected to the host computer. As a result, the simple transfer of files by directly transferring the files from the host computer can be unreliable due to inability of the proprietary point-to-point communications protocol to interoperate with the wireless network with its potentially large network latencies and potentially high error rates.

The use of communications protocol scripting allows the host computer to transfer the files to and from the wireless hub via a network aware communications protocol that is capable of good performance in the face of the performance problems associated with wireless communications, then the wireless hub can directly communicate to the electronic calculators using the proprietary point-to-point communications protocol over a wired network that does not have the same performance problems.

The wireless hub can have stored in its ROM (similar to the ROM 815 (FIG. 8)) a set of scripts that can enable the transfer of files to and from the electronic calculators. Furthermore, the host computer can download additional scripts to the wireless hub. For example, the host computer can communicate with the wireless hub via a series of commands. The commands can be used to inquire as to the status of the wireless hub, obtain information regarding the scripts installed in the wireless hub, remove scripts installed in the wireless hub, execute scripts, and so forth. Examples of the commands include: GET_LIST_OF_INSTALLED_SCRIPTS, CLEAR_SCRIPT_CACHE, LOAD_SCRIPT_INTO_CACHE, EXECUTE_SCRIPT, CANCEL_SCRIPT, GET_SCRIPT_STATUS, and GET_SCRIPT_RESULTS.

The scripts themselves can be a collection of commands that can be executed by the wireless hub. Upon execution in the wireless hub, the scripts can be translated into data and instruction flows across the network link connecting the wireless hub to the electronic calculator. Examples of the commands include: operations on data commands (SEND, RECV, RSET), program flow control commands (JUMP, WAIT, IF_THEN, IF_THEN_ELSE, WHILE, BREAK, CONT), host interaction commands (POST, STAT), and variable manipulation commands (SET, INC, DEC, TEST, BLOCKDATA).

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for encoding a file for transfer across multiple networks, the method comprising:
logically joining adjacent networks with network aware communications protocols into composite networks;
starting with an interface between a first composite network and a second composite network, wherein the interface is closest to a destination of the file transfer,
creating a script file using communications protocol instructions used by the second composite network, wherein the communications protocol instructions are used to transfer the file across the second composite network; and
repeating the creating at remaining interfaces between consecutive composite networks in a reverse order starting at the destination.

2. The method of claim 1, wherein adjacent networks using non-network aware communications protocols are converted into single network composite networks.

3. The method of claim 1, wherein a script file created for an interface contains script files created for all interfaces that are closer to the destination.

4. A method for transferring a file across multiple networks, the method comprising:
creating a script file on a first device;
transferring the script file to a network interface between the first device and a second device;
executing the script file on the network interface; and
informing the first device that the script file has been executed.

5. The method of claim 4, wherein the network interface is where two different networks meet.

6. The method of claim 4, wherein the script file contains the file, and wherein the executing of the script file transfers the file to the second device.

7. The method of claim 4, wherein the script file contains information about a file stored on the second device, and wherein the executing of the script file transfers the file from the second device to the network interface.

8. The method of claim 7 further comprising after the informing, retrieving the file from the network interface by the first device.

9. The method of claim 4, wherein there are multiple interfaces between the first device and the second device, and wherein the creating comprises:
starting with a network interface closest to the second device, creating a script file with communications protocol instructions for the network interface; and
repeating the creating for each remaining network interface, moving back from the network interface closest to the second device to the first device, wherein a script file created at a network interface immediately preceding a current network interface is contained in a script file created at the current network interface.

10. The method of claim 9, wherein the executing of the script file results in the stripping of an outermost set of communications protocol instructions from the script file and the transfer of the stripped script file from the network interface to the network interface immediately preceding the current network interface.

11. The method of claim 4, wherein the creating results in multiple script files.

12. The method of claim 4, wherein the executing comprises using a specific implementation of commands contained in the script file and stored in the network interface.

13. The method of claim 12, wherein the specific implementation translates commands contained in the script file into communications protocol instructions for a network link between the network interface and the second device.

14. The method of claim 4 further comprising after the transferring, buffering the script file at the network interface.

15. A network hub comprising:
a first network interface coupled to a first network connection;
a second network interface coupled to a second network connection;
a processor coupled to the first network interface and the second network interface, the processor is configured to execute script commands provided via the first network connection to transfer data and instructions through the first network interface and second network interface; and
a memory coupled to the processor, the memory is configured to store implementations of script commands, programs, and data.

16. The network hub of claim 15, wherein the processor comprises a command interpreter, wherein the command interpreter is configured to translate script commands provided by script files via the first network connection and executes the translated script commands.

17. The network hub of claim 16, wherein the command interpreter translates the script commands using implementations of the script commands stored in the memory.

18. The hub of claim 17, wherein the implementations of the script commands can be provided by a device connected to the hub via the first network connection.

19. The network hub of claim 17, wherein the network hub comprises more than two network interfaces, and wherein the memory stores an implementation of the script commands for each network connection.

20. The network hub of claim 15, wherein the memory comprises a read-only memory and a random access memory, and wherein the read-only memory stores implementations for a basic set of script commands and the random access memory can store implementations for an extended set of script commands.

21. The network hub of claim 15, wherein the first network connection is a wireless network link and the second network connection is a proprietary point-to-point link.

22. The network hub of claim 15, wherein the wireless network link is an IEEE 802.11 compliant network link.

23. The network hub of claim 15, wherein multiple devices can couple to the network hub via the second network connection.
